(19) United States
(12) Patent Application Publication
(10) Pub. No.: US 2008/0277619 A1
(43) Pub. Date: Nov. 13, 2008

(54) Thermoplastic Resin Composition with High Thermal Conductivity

(76) Inventors: Kazuaki Matsumoto, Osaka (JP); Tatsushi Yoshida, Osaka (JP)

Correspondence Address: BIRCH STEWART KOLASCH & BIRCH, PO BOX 747, FALLS CHURCH, VA, 22040-0747, US

(21) Appl. No.: 12/085,389

(22) PCT Filed: Dec. 7, 2006
(86) PCT No.: PCT/JP2006/324420

§ 371 Date: May 22, 2008

(30) Foreign Application Priority Data
Dec. 9, 2005 (JP) 2005-356104
Aug. 18, 2006 (JP) 2006-223563
Sep. 13, 2006 (JP) 2006-248358

(51) Int. Cl. F16L 59/00

(52) U.S. Cl. 252/62

(57) ABSTRACT

There are provided an inorganic compound-containing thermoplastic resin composition that practically retains various properties of a general-purpose resin such as mechanical properties and moldability and has excellent thermal conductivity, and a highly thermally conductive molded article molded using the resin composition.

In a polymer alloy comprising a thermoplastic resin excluding a thermoplastic polyester resin, a thermoplastic polyester resin and a highly thermally conductive inorganic compound, the thermoplastic polyester resin forms a continuous phase and the highly thermally conductive inorganic compound is preferentially present in a phase other than the thermoplastic resin excluding a thermoplastic polyester resin. Therefore, the composition and the highly thermally conductive molded article molded using the resin composition can have a thermal conductivity improved only by adding a relatively small amount of the highly thermally conductive inorganic compound.

### TECHNICAL FIELD

The present invention relates to a highly thermally conductive thermoplastic resin composition having high thermal conductivity and excellent moldability together and also having excellent practical properties such as impact strength.

### BACKGROUND ART

Thermoplastic polyester resins are thermoplastic resins having excellent mechanical properties, electrical properties, chemical resistance and the like and exhibiting excellent molding flowability when heated to a crystalline melting point or more of themselves, and are widely used mainly as resin compositions reinforced by inorganic compounds for structure materials or the like. However, the resins alone may not have sufficient impact resistance. Thus, in order to remedy drawbacks of thermoplastic polyester resins while maintaining their advantages, various technologies of alloying a thermoplastic polyester resin with another thermoplastic resin have been proposed.

On the other hand, when resin compositions are used for various applications such as enclosures of personal computers and displays, electronic device materials and automobile interior and exterior components, plastics have thermal conductivity lower than those of inorganic compounds such as metal materials and are thus difficult to allow generated heat to escape, disadvantageously. In order to solve such a problem, various attempts have been made to obtain a highly thermally conductive resin composition by adding a large amount of a highly thermally conductive inorganic compound in to the resin.

A method of adding an electrically conductive substance such as carbon fiber is usually used for obtaining a highly thermally conductive resin composition by adding an inorganic compound as described above. However, the resin composition by such a method has electrical conductivity and thus is cannot be used for an application requiring electrical insulation properties such as an electronic device material. On the other hand, in order to obtain a highly thermally conductive resin composition by a method of adding an inorganic compound having electrical insulation properties and high thermal conductivity, it is usually necessary to add a highly thermally conductive inorganic compound to a resin at a high content of 50 vol % or more.

However, when such a large amount of a highly thermally conductive inorganic compound is added to a thermoplastic resin, moldability of the thermoplastic resin is drastically decreased and it may be difficult to injection mold the resin into a complicated shape. Further, the large amount of the inorganic compound drastically decreases practical properties of the resin such as impact strength and the resulting material is extremely fragile, so that it is difficult to use the material for a large molded article and the material is used for limited applications, disadvantageously.

In order to solve such a problem, for example, Patent Document 1 shows that a composite resin composition having a polyamide resin as a sea phase and a polyphenylene ether resin as an island phase can be obtained with more excellent thermal conductivity by dispersing thermally conductive filler particles more in the polyamide resin as a sea phase to increase the dispersion density. Patent Document 2 reports a highly thermally conductive material having a thermally conductive powder selectively dispersed in a soft block phase of a block copolymer having a soft phase.

Patent Document 1: Japanese Patent Laid-Open No. Heisei 9(1997)-59511

Patent Document 2: Japanese Patent Laid-Open No. 2004-71385

### DISCLOSURE OF THE INVENTION

### Problems to be Solved by the Invention

When the above-described method of placing a highly thermally conductive inorganic compound only in a specific place to obtain a highly thermally conductive resin composition can be realized using a thermoplastic polyester resin, a highly thermally conductive material having excellent thermal conductivity can be obtained while reducing the amount of the expensive thermally conductive inorganic compound used; the material cost can be suppressed to be low because the amount of the thermally conductive inorganic compound used can be reduced; the thermally conductive inorganic compound can be mixed at a low concentration, making it possible to maintain moldability of the material; and it is possible to obtain an electrically insulating highly thermally conductive material that can be molded into a complicated shape, extremely usefully.

In view of the above circumstances, an object of the present invention is to provide an electrically insulating and inorganic compound-containing thermoplastic resin composition having excellent thermal conductivity while maintaining almost without deteriorating various excellent properties such as mechanical properties and moldability inherently possessed by a thermoplastic polyester resin.

### Means for Solving the Problems

The present inventors have found that a polymer alloy comprising a thermoplastic polyester resin and another thermoplastic resin has a highly thermally conductive inorganic compound preferentially placed mainly in the phase of the thermoplastic polyester resin, so that the thermal conductivity of the resin composition can be considerably increased by using only a small amount of the highly thermally conductive inorganic compound, and mechanical properties and moldability of the resulting composition are almost not impaired because the amount of the highly thermally conductive inorganic compound added can be reduced, for example. These findings have led to the completion of the present invention.

Specifically, the present invention is:

a highly thermally conductive thermoplastic resin composition comprising:

a thermoplastic resin excluding a thermoplastic polyester resin (A), a thermoplastic polyester resin (B) and a highly thermally conductive inorganic compound having a thermal conductivity of 1.5 W/m·K or more as a single substance (C),

wherein 1): the volume ratio of the component (A) to the component (B) is 15/85 to 75/25,
2): the volume ratio of the component (C) to the components {(A)+(B)} is 10/90 to 75/25,
3): the ratio of the component (C) present in a phase of the component (A) is a volume fraction of the component (A)×0.4 or less, and
4): at least the component (B) forms a continuous phase structure (claim 1);

The highly thermally conductive thermoplastic resin composition according to claim 1, wherein the component (C) is a highly thermally conductive inorganic compound having electrical insulation properties (claim 2);

The highly thermally conductive thermoplastic resin composition according to any one of claims 1 and 2,

wherein the component (C) has a volume average particle size of 1 nm or more and 12 μm or less and is one or more selected from metal oxide fine particles, metal nitride fine particles and insulating carbon fine particles (claim 3);

The highly thermally conductive thermoplastic resin composition according to any one of claims 1 to 3, wherein the component (C) contains at least one selected from boron nitride, aluminum nitride, silicon nitride, aluminum oxide, magnesium oxide, beryllium oxide and diamond (claim 4);

The highly thermally conductive thermoplastic resin composition according to any one of claims 1 to 4, wherein the thermoplastic resin excluding a thermoplastic polyester resin (A) is a polycarbonate resin (claim 5);

The highly thermally conductive thermoplastic resin composition according to any one of claims 1 to 4, wherein the thermoplastic resin excluding a thermoplastic polyester resin (A) is a polyamide resin (claim 6);

The highly thermally conductive thermoplastic resin composition according to any one of claims 1 to 4, wherein the thermoplastic resin excluding a thermoplastic polyester resin (A) is at least one thermoplastic resin synthesized using a styrene monomer and/or (meth)acrylic monomer (claim 7);

A highly thermally conductive molded article molded using the highly thermally conductive thermoplastic resin composition according to any one of claims 1 to 7 (claim 8); and

The highly thermally conductive molded article according to claim 8, wherein both the thermoplastic resin excluding a thermoplastic polyester resin (A) and the thermoplastic polyester resin (B) form a continuous phase structure (claim 9).

### EFFECTS OF THE INVENTION

In the field of highly thermally conductive resin compositions in which a large amount of a highly thermally conductive inorganic compound has been conventionally required, the amount of the inorganic compound can be considerably reduced by use of the process of the present invention. Therefore, a highly thermally conductive resin composition can be obtained inexpensively with excellent moldability and with properties inherently possessed by the resin almost not impaired.

The composite material obtained in this manner can be widely used in various forms such as a resin film, a resin molded article, a resin foam, a paint and a coating agent for various applications such as an electronic material, a magnetic material, a catalyst material, a structure material, an optical material, a medical material, an automobile material and a building material. The polymer material obtained by the present invention can be applied to a common plastic forming-machine widely used now such as an injection molding machine or extrusion molding machine and is thus easily molded into a product having a complicated shape. In particular, the material has well-balanced important properties such as moldability, impact resistance, chemical resistance and thermal conductivity and is thus extremely useful as a resin for an enclosure of a display or computer having an internal heat source.

### BRIEF DESCRIPTION OF THE DRAWING

FIG. 1 is a side view showing an example of a kneading apparatus that can be used for the production process of the present invention.

### DESCRIPTION OF SYMBOLS

1; First supply port
2; Vent port opened to atmospheric pressure
3; Second supply port
4; Vacuum vent port
5; Ejection port
6; Driving motor

### BEST MODE FOR CARRYING OUT THE INVENTION

The thermoplastic resin composition of the present invention comprises a thermoplastic resin excluding a thermoplastic polyester resin (A), a thermoplastic polyester resin (B) and a highly thermally conductive inorganic compound (C) as essential components.

As the component (A) of the present invention, it is possible to use any thermoplastic resin that can be mixed with a thermoplastic polyester resin. The thermoplastic resin is not particularly limited; however, among such resins, it is preferable to use one or more thermoplastic resins selected from a polycarbonate resin, a polyamide resin, and a thermoplastic resin synthesized using a styrene monomer and/or (meth)acrylic monomer. This is because they are easily alloyed with a thermoplastic polyester resin and a resin composition having well-balanced properties is easily produced, for example.

When the polycarbonate resin is used as the thermoplastic resin (A), the polycarbonate resin is a polycarbonate obtained by polymerizing a dihydric or higher polyhydric phenol compound with phosgene or a carbonic acid diester by a known method.

The dihydric phenol compound is not particularly limited. Examples of the compound include dihydroxydiarylalkanes such as 2,2-bis(4-hydroxyphenyl)propane [common name: bisphenol A], bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3-methyl-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane and 1,1-bis(4-hydroxyphenyl)-3,3,5-trimethylcyclohexane; dihydroxydiarylcycloalkanes such as 1,1-bis(4-hydroxyphenyl)cyclohexane and 1,1-bis(4-hydroxyphenyl)cyclodecane; dihydroxydiaryl sulfones such as bis(4-hydroxyphenyl) sulfone and bis(3,5-dimethyl-4-hydroxyphenyl) sulfone; dihydroxydiaryl ethers such as bis(4-hydroxyphenyl)ether and bis(3,5-dimethyl-4-hydroxyphenyl)ether; dihydroxydiaryl ketones such as 4,4′-dihydroxybenzophenone and 3,3′,5,5′-tetramethyl-4,4′-dihydroxybenzophenone; dihydroxydiaryl sulfides such as bis(4-hydroxyphenyl) sulfide, bis(3-methyl-4-hydroxyphenyl) sulfide and bis(3,5-dimethyl-4-hydroxyphenyl) sulfide; dihydroxydiaryl sulfoxides such as bis(4-hydroxyphenyl) sulfoxide; dihydroxydiphenyls such as 4,4′-dihydroxydiphenyl; dihydroxyarylfluorenes such as 9,9-bis(4-hydroxyphenyl)fluorene; dihydroxybenzenes such as hydroquinone, resorcinol and methylhydroquinone; and dihydroxynaphthalenes such as 1,5-dihydroxynaphthalene and 2,6-dihydroxynaphthalene.

These may be used singly or in a combination of two or more. Among these, bisphenol A is preferable. The carbonic acid diester is not particularly limited. Examples of the carbonic acid diester include diaryl carbonates such as diphenyl carbonate; and dialkyl carbonates such as dimethyl carbonate and diethyl carbonate. These may be used singly or in a combination of two or more.

The polycarbonate resin is not limited to a linear polycarbonate and may be a branched polycarbonate.

The branching agent used for obtaining the branched polycarbonate is not particularly limited. Examples of the branching agent include phloroglucin, mellitic acid, trimellitic acid, trimellitic acid chloride, trimellitic acid anhydride, gallic acid, n-propyl gallate, protocatechuic acid, pyromellitic acid, pyromellitic acid dianhydride, α-resorcylic acid, β-resorcylic acid, resorcinol aldehyde, isatinbis(o-cresol), benzophenonetetracarboxylic acid, 2,4,4′-trihydroxybenzophenone, 2,2′,4,4′-tetrahydroxybenzophenone, 2,4,4′-trihydroxyphenyl ether, 2,2′,4,4′-tetrahydroxyphenyl ether, 2,4,4′-trihydroxydiphenyl-2-propane, 2,2′-bis(2,4-dihydroxyphenyl)propane, 2,2′,4,4′-tetrahydroxydiphenylmethane, 2,4,4′-trihydroxydiphenylmethane, 1-[α-methyl-α-(4′-dihydroxyphenyl)ethyl]-3-[α′,α″-bis(4″-hydroxyphenyl)ethyl]benzene, 1-[α-methyl-α-(4′-dihydroxyphenyl)ethyl]-4-[α′,α′-bis(4″-hydroxyphenyl)ethyl]benzene, α,α′,α″-tris(4-hydroxyphenyl)-1,3,5-triisopropylbenzene, 2,6-bis(2-hydroxy-5′-methylbenzyl)-4-methylphenol, 4,6-dimethyl-2,4,6-tris(4′-hydroxyphenyl)-2-heptene, 4,6-dimethyl-2,4,6-tris(4′-hydroxyphenyl)-heptane, 1,3,5-tris(4′-hydroxyphenyl)benzene, 1,1,1-tris(4-hydroxyphenyl)ethane, 2,2-bis[4,4-bis(4′-hydroxyphenyl)cyclohexyl]propane, 2,6-bis(2′-hydroxy-5′-isopropylbenzyl)-4-isopropylphenol, bis[2-hydroxy-3-(2′-hydroxy-5′-methylbenzyl)-5-methylphenyl]methane, bis[2-hydroxy-3-(2′-hydroxy-5′-isopropylbenzyl)-5-methylphenyl]methane, tetrakis(4-hydroxyphenyl)methane, tris(4-hydroxyphenyl)phenylmethane, 2′,4′,7-trihydroxyflavan, 2,4,4-trimethyl-2′,4′,7-trihydroxyflavan, 1,3-bis(2′,4′-dihydroxyphenylisopropyl)benzene and tris(4′-hydroxyphenyl)-amyl-s-triazine.

The polycarbonate resin may sometimes be a polycarbonate-polyorganosiloxane copolymer composed of a polycarbonate moiety and a polyorganosiloxane moiety. In this case, the polyorganosiloxane moiety preferably has a polymerization degree of 5 or more.

Further, the polycarbonate resin may be a polycarbonate copolymer obtained by copolymerizing a linear aliphatic divalent carboxylic acid such as adipic acid, pimelic acid, suberic acid, azelaic acid, sebacic acid or decanedicarboxylic acid.

Various known terminators can be used for polymerizing the polycarbonate resin. Specific examples of the terminators include monohydric phenols such as phenol, p-cresol, p-t-butylphenol, p-t-octylphenol, p-cumylphenol and nonylphenol.

When flame retardance is necessary, the polycarbonate resin may be a polycarbonate copolymer with a phosphorus compound or may be a polycarbonate resin terminated with a phosphorus compound. In order to improve weather resistance, the polycarbonate resin may be a polycarbonate copolymer with a dihydric phenol having a benzotriazole group.

The polycarbonate resin preferably has a viscosity average molecular weight of 10000 to 60000. When the viscosity average molecular weight is less than 10000, the resulting resin composition often has insufficient strength, thermal resistance and the like. On the other hand, when the viscosity average molecular weight is more than 60000, moldability is often insufficient. The viscosity average molecular weight is more preferably 15000 to 45000, and still more preferably 18000 to 35000.

The polycarbonate resin may be used singly or in a combination of two or more. When the two or more resins are used in combination, the combination is not particularly limited. For example, it is possible to use any combination of the resins having different monomer units, different copolymerization molar ratios or different molecular weights, for example.

When the polyamide resin is used as the thermoplastic resin (A), the polyamide resin is a polymer containing an amide bond (—NHCO—) in the main chain and capable of being heat-melted Specific examples of the polyamide resin include polycaproamide (nylon 6), polytetramethylene adipamide (nylon 46), polyhexamethylene adipamide (nylon 66), polyhexamethylene sebacamide (nylon 610), polyhexamethylene dodecamide (nylon 612), polyundecamethylene adipamide (nylon 116), polyundecanamide (nylon 11), polydodecanamide (nylon 12), polytrimethylhexamethylene terephthalamide (nylon TMHT), polyhexamethylene isophthalamide (nylon 61), polyhexamethylene terephthal/isophthalamide (nylon 6T/61), polynonamethylene terephthalamide (nylon 9T), polybis(4-aminocyclohexyl)methane dodecamide (nylon PACM12), polybis(3-methyl-4-aminocyclohexyl)methane dodecamide (nylon dimethyl PACM12), polymethaxylylene adipamide (nylon MXD6), polyundecamethylene terephthalamide (nylon 11T), polyundecamethylene hexahydroterephthalamide (nylon 11T(H)) and their copolymerized polyamides and mixed polyamides.

Among these, nylon 6, nylon 46, nylon 66, nylon 11, nylon 12, nylon 9T, nylon MXD6 and their copolymerized polyamides and mixed polyamides are preferable in terms of availability, handleability and the like. Nylon 6, nylon 46, nylon 66 and nylon MXD6 are more preferable in terms of strength, modulus of elasticity, cost and the like.

The molecular weight of the polyamide resin is not particularly limited; however, usually, a polyamide resin having a relative viscosity of 0.5 to 5.0 measured in concentrated sulfuric acid at 25° C. is preferably used.

The polyamide resin may be used singly or in a combination of two or more having different compositions or components and/or different relative viscosities.

The polyamide resin can be produced by a common polyamide polymerization method, for example.

In the thermoplastic resin composition of the present invention, the polyamide resin may be used singly or in a combination of two or more. When the two or more resins are used in combination, the combination is not particularly limited and any combination is possible.

When the thermoplastic resin synthesized using a styrene monomer and/or (meth)acrylic monomer is used as the thermoplastic resin (A), the thermoplastic resin synthesized using a styrene monomer and/or (meth)acrylic monomer may be sufficient if synthesized using a styrene monomer and/or (meth)acrylic monomer and is not particularly limited.

Examples of the styrene monomer that can be used include styrene as well as α-methylstyrene, o-methylstyrene, p-methylstyrene, ethylstyrene, dimethylstyrene, p-t-butylstyrene, 2,4-dimethylstyrene, methoxystyrene, bromostyrene, fluorostyrene, hydroxystyrene, aminostyrene, cyanostyrene, nitrostyrene, chloromethylstyrene, acetoxystyrene and p-dimethylaminomethylstyrene.

The (meth)acrylic monomer in the present invention refers to both a methacrylic monomer and an acrylic monomer. Many known such monomers can be used in the present invention. Specific examples of such monomers may include (meth)acrylic acid, methyl(meth)acrylate, ethyl(meth)acrylate, propyl(meth)acrylate and butyl (meth)acrylate, and they can be suitably used.

The thermoplastic resin (A) synthesized using a styrene monomer and/or (meth)acrylic monomer may be sufficient if synthesized using such a monomer. Examples of the resin include polystyrene, rubber modified polystyrene (HIPS resin), a styrene-acrylonitrile copolymer and a styrene-rubbery polymer-acrylonitrile copolymer. Examples of the styrene-rubbery polymer-acrylonitrile copolymer include an ABS (acrylonitrile-butadiene-styrene) resin, AES (acrylonitrile-ethylene/propylene/diene-styrene) resin, AAS (acrylonitrile-acrylic rubber-styrene) resin and ACS (acrylonitrile-chlorinated polyethylene-styrene) resin. These can be used singly or in a combination of two or more.

Further, part of styrene and/or part or whole of acrylonitrile in the thermoplastic resin may be substituted with the styrene monomer excluding styrene and/or the (meth)acrylic monomer to the extent that the resulting resin exhibits thermoplastic properties. As the styrene monomer and/or (meth)acrylic monomer used for the substitution, those such as α-methylstyrene, p-methylstyrene, p-t-butylstyrene; (meth)acrylic acid ester compounds such as methyl(meth)acrylate, ethyl (meth)acrylate, propyl(meth)acrylate and n-butyl (meth)acrylate; maleimide monomers such as maleimide, N-methylmaleimide, N-cyclohexylmaleimide and N-phenylmaleimide; and unsaturated carboxylic acid monomers such as acrylic acid, methacrylic acid, maleic acid, fumaric acid and itaconic acid, which are vinyl monomers copolymerizable with a styrene monomer, can be preferably used to the extent that the resulting resin exhibits thermoplastic properties. These can be used singly or in a combination of two or more.

Preferable examples include an ABS resin, polystyrene, an HIPS resin, an AES resin, an AAS resin, an ACS resin, an MBS (methyl methacrylate-butadiene-styrene) resin, a polymethyl methacrylate resin, an MB (methyl methacrylate-butadiene) resin and an imidized polymethyl methacrylate resin.

An ABS resin, polystyrene, a polymethyl methacrylate resin or an MB (methyl methacrylate-butadiene) resin is more preferable. Among these, an ABS resin, polystyrene, or a methyl methacrylate resin which may or may not be modified by butadiene is preferable. Such a resin tends to be easily alloyed with the thermoplastic polyester resin (B).

The method for producing the styrene resin is not particularly limited and a common method such as bulk polymerization, suspension polymerization, emulsion polymerization or bulk-suspension polymerization can be used.

The styrene resin used in the present invention is not particularly limited insofar as the effect of the present invention is not impaired. However, an ABS resin is particularly preferably used from the viewpoint of a balance in properties of the thermoplastic polyester resin composition obtained by the present invention, compatibility with thermoplastic polyester and economy. For example, the ABS resin may be an ABS resin composed of a copolymer composed of 40 to 80 wt % of an aromatic vinyl compound, 15 to 50 wt % of a vinyl cyanide compound and 0 to 30 wt % of another copolymerizable vinyl compound; and a graft copolymer obtained by graft copolymerization of 70 to 5 wt % of a graft copolymerizable vinyl compound in the presence of 30 to wt % of a rubbery polymer having an average particle size of 0.01 to 5.0 μm.

As the graft copolymer, a graft copolymer obtained by graft copolymerization of 70 to 5 wt % of a graft copolymerizable vinyl compound in the presence of 30 to 95 wt % of a rubbery polymer having an average particle size of 0.01 to 5.0 μm is preferably used.

As the graft copolymerizable vinyl compound, it is possible to use an aromatic vinyl compound, a vinyl cyanide compound or another copolymerizable vinyl compound. These are all used singly or in a combination of two or more. When the amount of the rubbery polymer is more than 95 wt %, impact resistance and oil resistance may be decreased. When the amount of the rubbery polymer is less than 30 wt %, impact resistance may be decreased. Examples of the rubbery polymer include butadiene.

As the rubbery polymer used in the graft copolymer, a rubbery polymer having a weight average particle size of 0.01 to 5.0 μm is preferably used in terms of impact resistance and molded article appearance of the thermoplastic polyester resin composition. A rubbery polymer having a weight average particle size of 0.02 to 2.0 μm is particularly preferable. Further, in order to improve impact strength, it is possible to use a rubbery polymer latex obtained by aagglomeration and enlargement of a small particle rubbery polymer latex and preferably having the above-described weight average particle size.

As the method for agglomeration and enlargement of a small particle rubbery polymer latex, it is possible to use a conventionally known method such as a method of adding an acidic substance (Japanese Patent Publication No. 42-3112, Japanese Patent Publication No. 55-19246, Japanese Patent Publication No. 2-9601, Japanese Patent Laid-Open No. 63-117005, Japanese Patent Laid-Open No. 63-132903, Japanese Patent Laid-Open No. 7-157501 and Japanese Patent Laid-Open No. 8-259777) or a method of adding an acid group-containing latex (Japanese Patent Laid-Open No. 56-166201, Japanese Patent Laid-Open No. 59-93701, Japanese Patent Laid-Open No. 1-126301; Japanese Patent Laid-Open No. 8-59704 and Japanese Patent Laid-Open No. 9-217005) without particular limitations.

Examples of the method for producing the copolymer and graft copolymer include bulk polymerization, suspension polymerization, solution polymerization, emulsion polymerization and their combinations, that is, emulsion-suspension polymerization and emulsion-bulk polymerization. When emulsion polymerization is used, a common method may be applied. That is, the above-described compound may be reacted in an aqueous medium in the presence of a radical initiator. In this case, the above-described compound may be used as a mixture or as divided according to need. Further, the above-described compound may be added all at once or sequentially, and the addition method is not particularly limited.

Examples of the radical initiator include potassium persulfate, ammonium persulfate and water-soluble or oil-soluble peroxides such as cumene hydroperoxide and p-menthane hydroperoxide. These are used singly or in a combination of two or more. In addition, a polymerization promoter, a polymerization degree regulator and an emulsifier used in known emulsion polymerization may be appropriately selected and used.

A dried resin may be obtained from the resulting latex by a known method. In this case, the dried resin may be obtained after mixing the copolymer latex with the graft copolymer latex, or the dried resins may be obtained separately from the copolymer latex and the graft copolymer latex and then mixed in a powder state. As the method for obtaining the resin from the latex, a method of adding an acid such as hydrochloric acid, sulfuric acid or acetic acid or a metal salt such as calcium chloride, magnesium chloride or aluminum sulfate to coagulate the latex and then dehydrating and drying the latex is used, for example. The mixed resin of the copolymer and the graft copolymer produced in the manner as described above retains properties of an ABS resin and also exhibits high compatibility with a thermoplastic polyester resin.

As the thermoplastic resin synthesized using a (meth)acrylic monomer, a copolymer of an olefin monomer and a (meth)acrylic monomer can also be preferably used. Among such copolymers, it is preferable to use a copolymer containing at least one olefin unit and at least one (meth)acrylic acid glycidyl ester unit or a copolymer containing at least one olefin unit and at least one (meth)acrylic acid alkyl ester unit.

The copolymer is generally obtained by radical polymerization of one or more olefin units and one or more (meth)acrylic units in the presence of a radical initiator; however, the polymerization method is not limited thereto and polymerization can be carried out using various generally known polymerization methods. The copolymer may be a random copolymer or a block copolymer.

Specific examples of the olefin in the copolymer include ethylene, propylene, 1-butene and 1-pentene. These olefins are used singly or in a combination of two or more. The olefin is particularly preferably ethylene.

Specific examples of the (meth)acrylic monomer in the copolymer include glycidyl acrylate, glycidyl methacrylate, methyl acrylate, ethyl acrylate, n-propyl acrylate, i-propyl acrylate, n-butyl acrylate, t-butyl acrylate, methyl methacrylate, ethyl methacrylate, n-propyl methacrylate, i-propyl methacrylate, n-butyl methacrylate and t-butyl methacrylate. These are used singly or in a combination of two or more. The (meth)acrylic monomer is particularly preferably glycidyl methacrylate, methyl acrylate, ethyl acrylate or butyl acrylate.

The copolymer has a melt index (MI) value of 0.2 to 1000 g/10 min, preferably 0.3 to 500 g/10 min, and more preferably 0.5 to 300 g/10 min at 190° C. under a load of 2 kg (in accordance with JIS K6730). When the MI value is less than 0.2, moldability of the resulting composition tends to be decreased. When the MI value is more than 1000, the effect of improving impact resistance of the resulting composition tends to be decreased.

The one or more olefin units are copolymerized with the one or more (meth)acrylic units in the copolymer so that the amount of the one or more (meth)acrylic units is preferably 0.1 to 55 wt %, and more preferably 1 to 41 wt % based on 100 wt % of the copolymer. When the amount of the (meth)acrylic monomer units is less than 0.1 wt %, the effect of improving impact resistance tends to be small. When the amount is more than 41 wt %, it tends to be difficult to mold the resulting composition. The copolymer is used singly or in a combination of two or more having different copolymerization components or MI values.

Other components may be copolymerized in addition to the olefin units and the (meth)acrylic monomer units. Preferable examples of the copolymerization components include vinyl acetate units and carbon monoxide units.

Various thermoplastic resins other than the above examples can be used as the thermoplastic resin (A) in the present invention. The thermoplastic resins are not particularly limited. Examples thereof include a polyolefin resin, a polyphenylene sulfide resin, a polyphenylene ether resin, a polyacetal resin and a polysulfone resin. These may be used singly or in a combination of two or more.

In the present invention, the thermoplastic resin (A) may be used singly or in a combination of two or more. When the two or more resins are used in combination, the combination is not particularly limited. For example, it is possible to use any combination of the resins having different monomer units, different copolymerization molar ratios or different molecular weights, for example.

The thermoplastic polyester resin (B) contained in the thermoplastic resin composition of the present invention is a thermoplastic polyester obtained by polycondensation of a divalent or higher polyvalent carboxylic acid compound and a dihydric or higher polyhydric alcohol and/or phenol compound by a known method. Specific examples of the resin include polyethylene terephthalate, polypropylene terephthalate, polybuthylene terephthalate, polyhexamethylene terephthalate, polycyclohexanedimethylene terephthalate, polyethylene naphthalate and polybutylene naphthalate. However, the resin is not limited to these examples.

The divalent or higher polyvalent carboxylic acid compound is not particularly limited and may be a divalent or higher polyvalent aromatic carboxylic acid having 8 to 22 carbon atoms or an ester forming derivative thereof, for example. Specific examples of the compound include phthalic acids such as terephthalic acid and isophthalic acid; carboxylic acids such as naphthalenedicarboxylic acid, bis(p-carboxyphenyl)methane, anthracenedicarboxylic acid, 4,4′-diphenyldicarboxylic acid, 1,2-bis(phenoxy)ethane-4,4′-dicarboxylic acid, diphenylsulfonedicarboxylic acid, trimesic acid, trimellitic acid and pyromellitic acid; and their derivatives having ester forming ability. These may be used singly or in a combination of two or more. Among these, terephthalic acid, isophthalic acid or naphthalenedicarboxylic acid is preferable in terms of handling easiness, reaction easiness and properties of the resulting resin composition.

The dihydric or higher hydric alcohol and/or phenol compound is not particularly limited and may be an aliphatic compound having 2 to 15 carbon atoms, an alicyclic compound having 6 to 20 carbon atoms or an aromatic compound having 6 to 40 carbon atoms, the compound having two or more hydroxyl groups in the molecule, or an ester forming derivative thereof, for example.

Specific examples of the compound include ethylene glycol, propylene glycol, butanediol, hexanediol, decanediol, neopentyl glycol, cyclohexanedimethanol, cyclohexanediol, 2,2′-bis(4-hydroxyphenyl)propane, 2,2′-bis(4-hydroxycyclohexyl)propane, hydroquinone, glycerol, pentaerythritol and their derivatives having ester forming ability. These may be used singly or in a combination of two or more. Among these, ethylene glycol, butanediol or cyclohexanedimethanol is preferable in terms of handling easiness, reaction easiness and properties of the resulting resin composition.

The thermoplastic polyester resin (B) may be obtained by copolymerizing a known copolymerizable compound together with the carboxylic acid compound and the alcohol and/or phenol compound described above to the extent that desired properties are not impaired. Such a copolymerizable compound is not particularly limited and may be a divalent or higher polyvalent aliphatic carboxylic acid having 4 to 12 carbon atoms, a divalent or higher polyvalent alicyclic carboxylic acid having 8 to 15 carbon atoms or an ester forming derivative thereof, for example.

Examples of the copolymerizable compound include dicarboxylic acids such as adipic acid, sebacic acid, azelaic acid, dodecanedicarboxylic acid, maleic acid, 1,3-cyclohexanedicarboxylic acid and 1,4-cyclohexanedicarboxylic acid or their derivatives having ester forming ability. Other examples include oxyacids such as p-hydroxybenzoic acid or their ester forming derivatives; and cyclic esters such as ε-caprolactone.

The thermoplastic polyester resin (B) may be a thermoplastic polyester resin obtained by copolymerizing a polyalkylene glycol to form its unit in the part of the polymer chain. Such a polyalkylene glycol is not particularly limited. Examples of the polyalkylene glycol include polyethylene glycol, polypropylene glycol, a poly(ethylene oxide-propylene oxide) block and/or random copolymer, a bisphenol A-polyethylene oxide addition polymer, a bisphenol A-polypropylene oxide addition polymer, a bisphenol A-polytetrahydrofuran addition polymer and polytetramethylene glycol.

The amount of the above-described copolymerization component used in the thermoplastic polyester resin (B) is usually 20 wt % or less, preferably 15 wt % or less, and more preferably 10 wt % or less.

The thermoplastic polyester resin (B) is preferably a polyalkylene terephthalate containing 80 wt % or more of an alkylene terephthalate unit, because the resulting resin composition has well-balanced properties (for example, moldability). The resin is more preferably a polyalkylene terephthalate containing 85 wt % or more, and still more preferably 90 wt % or more of the same unit.

The thermoplastic polyester resin (B) preferably has an inherent viscosity (IV) of 0.30 to 2.00 dl/g or more when measured in a phenol/tetrachloroethane=1/1 (weight ratio) mixed solvent at 25° C. When the inherent viscosity is less than 0.30, the molded article often has insufficient flame retardance and mechanical strength. When the inherent viscosity is more than 2.00 dl/g, molding flowability tends to be decreased. The inherent viscosity is more preferably 0.40 to 1.80 dl/g, and still more preferably 0.50 to 1.60 dl/g.

In the thermoplastic resin composition of the present invention, the thermoplastic polyester resin (B) may be used singly or in a combination of two or more. When the two or more resins are used in combination, the combination is not particularly limited. For example, it is possible to use any combination of the resins having different copolymer components or molar ratios or different molecular weights, for example.

The thermoplastic resin composition of the present invention has a volume ratio of the thermoplastic resin (A) to the thermoplastic polyester resin (B) [(A)/(B)] of 15/85 to 75/25. When the ratio is less than 15/85, dimension stability, impact resistance and the like tend to be decreased. When the ratio is more than 75/25, thermal stability, solvent resistance and the like of the resulting molded article tend to be decreased.

The mixing ratio of the thermoplastic resin (A) to the thermoplastic polyester resin (B) [(A)/(B)] must be determined so that at least the thermoplastic polyester resin (B) forms a continuous phase structure in the micro-phase separation structure in the resin composition. The ratio of each component may be determined so that the thermoplastic resin (A) as the other resin component forms an island structure or a substantially continuous phase structure.

Preferably, the thermoplastic resin (A) also forms a continuous phase structure and forms a mutually continuous phase structure together with the thermoplastic polyester resin (B). Such a phase structure is formed so that impact strength of the resulting resin composition is improved. Moreover, the highly thermally conductive inorganic compound dispersed more in the thermoplastic polyester resin is mutually brought into contact, so that the whole composition has thermal conductivity improved.

The volume ratio is preferably 20/80 to 70/30, more preferably 25/75 to 65/35, still more preferably 28/72 to 60/40, and most preferably 30/70 to 55/45.

Most of the highly thermally conductive inorganic compound (C) is present in the phase of the thermoplastic polyester resin (B). Accordingly, when the resulting composition is observed under an electron microscope or the like, it is seen from the obtained photograph that the percentage of the thermoplastic polyester resin (B) is greater than that based on the mixing ratio. For example, when the components are mixed at a volume ratio (A)/(B)/(C)=35/35/30 and all the component (C) is present in the component (B), the apparent volume ratio is seen as (A)/{(B)+(C)}=35/65.

However, the ratio of the thermoplastic resin (A) to the thermoplastic polyester resin (B) according to the present invention is a volume ratio excluding the component (C). Therefore, even in the above case, it is defined that [(A)/(B)]=50/50. Accordingly, the volume ratio [(A)/(B)] is almost the same value as the mixing ratio of both resins.

As the highly thermally conductive inorganic compound (C) contained in the thermoplastic resin composition of the present invention, it is possible to use a compound having a thermal conductivity of 1.5 W/m·K or more as a single substance. When the thermal conductivity is less than 1.5 W/m·K, the effect of improving the thermal conductivity of the composition is inferior, undesirably. The thermal conductivity of the single substance used is preferably 4 W/m·K or more, more preferably 9 W/m·K or more, most preferably 20 W/m·K or more, and particularly preferably 30 W/m·K or more.

The upper limit of the thermal conductivity of the highly thermally conductive inorganic compound (C) as a single substance is not particularly limited and is preferably as high as possible. The compound having a thermal conductivity of generally 3000 W/m·K or less, and furthermore 2500 W/m·K or less is preferably used.

The preferable range may be 4 W/m·K to 3000 W/m·K, furthermore 9 W/m·K to 2800 W/m·K, and particularly 30 W/m·K to 2500 W/m·K, for example.

Various well-known inorganic compounds can be used as the highly thermally conductive inorganic compound (C). Examples of the inorganic compounds include metals such as gold, silver, copper, aluminum, iron, magnesium and nickel, and alloys of these metals; metal oxides such as aluminum oxide, magnesium oxide, silicon oxide, zinc oxide, beryllium oxide, copper oxide and cuprous oxide; metal nitrides such as boron nitride, aluminum nitride and silicon nitride; metal carbides such as silicon carbide; and carbon materials such as carbon, graphite and diamond.

However, among these various exemplified highly thermally conductive inorganic compounds, it is necessary to select a compound that is dispersed more in the thermoplastic polyester resin (B) and is difficult to be dispersed in the thermoplastic resin excluding a thermoplastic polyester resin (A). These inorganic compounds may be natural substances or synthesized substances. The natural substances are not particularly limited in terms of the place of origin and can be appropriately selected.

On the other hand, the highly thermally conductive resin composition is often required to have electrical insulation properties when used for electronic device applications. In order to use the resin composition of the present invention for such applications, a compound having electrical insulation properties is used as the highly thermally conductive inorganic compound (C). The compound having electrical insulating properties specifically refers to a compound having an electrical resistivity of 1 Ω·cm or more. However, it is preferable to use a compound having an electrical resistivity of preferably 10 Ω·cm or more, more preferably 10⁵ Ω·cm or more, still more preferably 10¹⁰ Ω·cm or more, and most preferably 10¹³ Ω·cm or more.

The upper limit of the electrical resistivity is not particularly limited; however, a compound having an electrical resistivity of 10¹⁸ Ω·cm or less is generally used. A molded article obtained from the highly thermally conductive thermoplastic resin composition of the present invention preferably has electrical insulation properties within the above range.

Specifically, metal oxides such as aluminum oxide, magnesium oxide, silicon oxide, zinc oxide, beryllium oxide, copper oxide and cuprous oxide; metal nitrides such as boron nitride, aluminum nitride and silicon nitride; and metal carbides such as silicon carbide can be preferably used. Among these, metal oxides such as aluminum oxide, magnesium oxide, beryllium oxide, copper oxide and cuprous oxide; and metal nitrides such as boron nitride, aluminum nitride and silicon nitride can be more preferably used due to excellent electrical insulation properties.

These can be used singly or in a combination of two or more. These metal oxides and metal nitrides may have properties as a semiconductor depending on the type of the metal. Even in this case, it is preferable to select a metal oxide or metal nitride having an electrical conductivity as low as possible.

Various shapes can be applied to the highly thermally conductive inorganic compound (C). Examples include various shapes such as shapes of particles, fine particles, nanoparticles, aggregated particles, tubes, nanotubes, wires, rods, needles, plates, amorphous forms, rugby balls, hexahedrons, composite particles in which large particles and fine particles form a composite, and liquids.

However, in order to efficiently mix the highly thermally conductive inorganic compound with the resins, it is preferable to use fine particles having a shape close to spheres, or a liquid compound. Among these, it is preferable to use one or more selected from metal oxide fine particles, metal nitride fine particles and insulating carbon fine particles having a volume average particle size of 1 nm or more and 12 μm or less. This is because the highly thermally conductive inorganic compound (C) is smaller than the size of the phase structure of the thermoplastic polyester resin (B) so that the highly thermally conductive inorganic compound (C) can be preferentially present in the phase of the thermoplastic polyester resin (B). Further, the highly thermally conductive inorganic compound having such a size can be easily melt kneaded with the resin composition.

When the volume average particle size is more than 12 μm, the resulting molded article tends to have appearance impaired and the resin composition tends to have impact strength decreased. Moreover, since the particle size is larger than the size of the phase structure of the thermoplastic polyester resin (B), it tends to be difficult to make the particles selectively present in the thermoplastic polyester resin (B). When the volume average particle size is less than 1 nm, the inorganic compound has an enormous surface area, and thus the inorganic compound tends to have surface thermal resistance increased and thermal conductivity decreased.

The volume average particle size is preferably 5 nm to 11 μm, more preferably 20 nm to 10 μm, still more preferably 40 nm to 8 μm, particularly preferably 100 nm to 7.5 μm, and most preferably 100 nm to 6 μm.

The volume average particle size in the present invention is defined as a value measured by a method of observing appearance of a powder under an electronic microscope or optical microscope; converting the observed appearance into a circle having the same area when the appearance is not a circle; and then measuring the diameter of the circle to calculate the volume average.

The highly thermally conductive inorganic compound (C) when added may be surface treated with various surface treatment agents such as silane treatment agents in order to increase adhesion in the interface between the resin and the inorganic compound and increase workability. Conventionally known surface treatment agents such as silane coupling agents and titanate coupling agents can be used without particular limitations. Among them, epoxy group-containing silane coupling agents such as epoxysilane; amino group-containing silane coupling agents such as aminosilane; polyoxyethylenesilane; and the like are preferable, because properties of the resin rarely deteriorate. The surface treatment method for the inorganic compound is not particularly limited and a common treatment method can be used.

The highly thermally conductive inorganic compound (C) may be used singly or in a combination of two or more differing in average particle size, type, surface treatment agent and the like.

The highly thermally conductive inorganic compound (C) must be contained in the thermoplastic resin composition of the present invention so that the volume ratio of the highly thermally conductive inorganic compound (C) to the total of the thermoplastic resin excluding a thermoplastic polyester resin (A) and the thermoplastic polyester resin (B), (C)/{(A)+(B)}, is 10/90 to 75/25. When the volume ratio of less than 10/90, the effect of improving thermal conductivity is inferior, undesirably.

When the volume ratio is more than 75/25, impact resistance, surface properties and moldability of the resulting molded article tends to be decreased and kneading with the resins tends to be difficult during melt kneading. The preferable range of the volume ratio may be 15/85 to 72/28, furthermore 20/80 to 69/31, and particularly 23/77 to 67/33, for example.

In the thermoplastic resin composition of the present invention, the ratio of the highly thermally conductive inorganic compound (C) present in the thermoplastic resin excluding a thermoplastic polyester resin (A) based on the total volume of the highly thermally conductive inorganic compound (C) must be: volume of component (A)/{volume of component (A)+volume of component (B)}×0.4 or less. This efficiently increases thermal conductivity of the resulting thermoplastic resin composition. As a result, the whole composition can have a thermal conductivity increased and various properties such as mechanical properties and moldability almost not decreased and maintained only by addition of a small amount of the highly thermally conductive inorganic compound.

In particular, the ratio of the inorganic compound (C) present in the phase of the component (A) based on the total volume of the inorganic compound (C) is preferably: volume of component (A)/{volume of component (A)+volume of component (B)}×0.3 or less.

More preferably, the ratio of the inorganic compound (C) present in the phase of the component (A) based on the total volume of the inorganic compound (C) is: volume of component (A)/{volume of component (A)+volume of component (B)}×0.25 or less. Still most preferably, the ratio of the inorganic compound (C) present in the phase of the component (A) based on the total volume of the inorganic compound (C) is: volume of component (A)/{volume of component (A)+volume of component (B)}×0.2 or less. Most preferably, the ratio of the inorganic compound (C) present in the phase of the component (A) based on the total volume of the inorganic compound (C) is: volume of component (A)/{volume of component (A)+volume of component (B)}×0.1 or less.

As the ratio of the inorganic compound (C) present in the thermoplastic resin excluding a thermoplastic polyester resin (A) is smaller, thermal conductivity of the composition can be improved by a smaller amount of the highly thermally conductive inorganic compound.

The ratio of the highly thermally conductive inorganic compound (C) present can be measured by observing a product cut from the thermoplastic resin composition of the present invention under a transmission electron microscope and measuring the total volume of the inorganic compound (C) viewed within its field of view and the volume of the highly thermally conductive inorganic compound (C) present in the phase of the thermoplastic resin excluding a thermoplastic polyester resin (A) viewed within its field of view, respectively. (Here, the phase of the thermoplastic resin excluding a thermoplastic polyester resin (A) can be distinguished from the phase of the thermoplastic polyester resin (B) under an electron microscope.)

Here, when there is the highly thermally conductive inorganic compound (C) present near the interface between the thermoplastic resin excluding a thermoplastic polyester resin (A) and the thermoplastic polyester resin (B) to cross both components, the interface between the thermoplastic resin excluding a thermoplastic polyester resin (A) and the thermoplastic polyester resin (B) is extended to a place where the highly thermally conductive inorganic compound (C) is present to set an apparent interface between both components, so that the ratio of the highly thermally conductive inorganic compound (C) present is calculated.

A non-thermoplastic resin such as a thermosetting resin or crosslinked resin may be further added to the thermoplastic resin composition of the present invention, in addition to the components (A) and (B), to the extent that the object of the present invention is not impaired. Such an optional component resin is not particularly limited. Examples of the resin include a fluorinated polyolefin resin such as polytetrafluoroethylene, a phenol resin, an epoxy resin, a curable silicone resin and a cellulose resin. These may be added singly or in a combination of two or more.

An inorganic compound other than the highly thermally conductive inorganic compound (C) can be further added to the thermoplastic resin composition of the present invention in order to increase thermal resistance and mechanical strength of the resin composition, to the extent that the features of the present invention are not impaired. Such a reinforcing filler is not particularly limited. However, since thermal conductivity and insulating properties may be affected by addition of the inorganic compound, it is necessary to be careful of the amount added and the like.

The inorganic compound may be surface treated. When used, the reinforcing filler is added in an amount of 100 weight or less based on 100 parts by weight in total of the thermoplastic resin excluding a thermoplastic polyester resin (A) and the thermoplastic polyester resin (B).

When the amount added is more than 100 parts by weight, impact resistance is decreased and formability and flame retardance may also be decreased. The amount is more preferably 50 parts by weight or less, and still more preferably 10 parts by weight or less. As the amount of the reinforcing filler added is increased, surface properties and dimension stability of the molded article tend to deteriorate. Therefore, when these properties are important, the amount of the reinforcing filler added is preferably as small as possible.

In order to increase performance of the thermoplastic resin composition of the present invention, antioxidants such as phenol antioxidants and thioether antioxidants; and thermal stabilizers such as phosphorus stabilizers are preferably added singly or in a combination of two or more. Generally well-known agents such as stabilizers, lubricants, release agents, plasticizers, flame retardants other than phosphorus flame retardants, flame retarding assistants, UV absorbers, light stabilizers, pigments, dyes, antistatic agents, conductivity imparting agents, dispersants, compatibilizers and antibacterial agents may be further added singly or in a combination of two or more according to need.

The process for producing the thermoplastic resin composition of the present invention is not particularly limited. For example, the composition can be produced by drying the above-described components and additives and the like and then melt kneading them in a melt kneader such as a single-screw or twin-screw extruder. The composition can also be produced by adding the components to a melt kneader using a liquid supply pump or the like in the middle when the components are liquids.

The preferable production process is a process for producing the thermoplastic resin composition of the present invention in a kneading apparatus having at least a first supply port provided in the root of the kneading apparatus; a second supply port provided downstream of the first supply port; and a vent port that is provided in a position closer to the second supply port between the first supply port and the second supply port and opened to atmospheric pressure, the process comprising supplying 30 wt % or more of the amount of the highly thermally conductive inorganic compound (C) added among the above-described raw materials of the composition from the second supply port and, on the other hand, supplying the remaining raw materials from the first supply port.

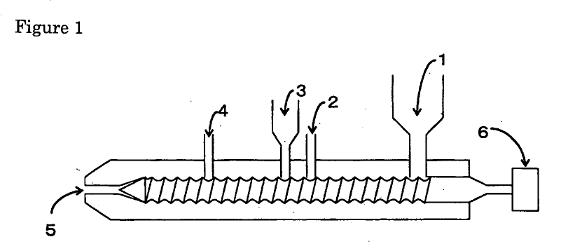

The production process of the present invention can be typically carried out using an apparatus shown in FIG. 1, for example. The component (A), the component (B) and 70 wt % or less of the component (C) are introduced into a first supply port 1 in FIG. 1. The introduced raw materials are transported in the downstream direction, kneaded and moved in the kneading apparatus. From a second supply port 3, 30 wt % or more of the component (C) is supplied. A vent port 2 is provided in apposition closer to the second supply port 3 between the first supply port 1 and the second supply port 3 and is opened to atmospheric pressure. The raw materials are kneaded and transported in the downstream direction at the same time and ejected from an ejection port 5.

When such a production process is used, the thermoplastic resin excluding a thermoplastic polyester resin (A) is sufficiently kneaded with the thermoplastic polyester resin (B) and, at the same time, the highly thermally conductive inorganic compound (C) is difficult to enter the thermoplastic resin phase synthesized using a styrene monomer and/or (meth)acrylic monomer. Therefore, it is possible to easily produce the thermoplastic resin composition having the above-described dispersion state of the highly thermally conductive inorganic compound (C). In particular, dispersion of the highly thermally conductive inorganic compound (C) can be controlled more easily as compared with a case where the whole amount of the highly thermally conductive inorganic compound (C) is collectively supplied from a supply port common with the components (A) and (B) and a case where the highly thermally conductive inorganic compound (C) is supplied from a second supply port but a vent port opened to atmospheric pressure is not used.

In this production process, the amount of the highly thermally conductive inorganic compound (C) supplied from the second supply port is preferably 30 wt % or more, more preferably 50 wt % or more, and still more preferably 70 wt % or more based on the total amount of the highly thermally conductive inorganic compound (C) added. The total amount of the highly thermally conductive inorganic compound (C) can also be added from the second supply port.

In the kneading apparatus, the position of the vent port 2 opened to atmospheric pressure is preferably a position closer to the second supply port 3 between the first supply port 1 and the second supply port 3. A vacuum vent port 4 can be further provided downstream of the second supply port 3.

The kneading apparatus used in the production process of the present invention is not particularly limited and a known kneading apparatus can be used. Specific examples of the kneading apparatus include a co-rotating intermeshed twin-screw extruder. Among these, a twin-screw extruder is preferable in order to sufficiently knead the thermoplastic resin synthesized using a styrene monomer and/or (meth)acrylic monomer (A) and the thermoplastic polyester resin (B).

The twin-screw extruder is not particularly limited and a conventionally known extruder can be used. The screw may be co-rotated or counter-rotated. More preferably, the twin-screw extruder has a structure retaining a resin between the first supply port 1 and the second supply port 2, such as a kneading disk or reverse screw structure or a structure with a narrowed interval between the screw and the wall. The vent port 2 opened to atmospheric pressure may be provided immediately downstream of such a structure retaining a resin.

In the production process of the present invention, the number of screw revolutions in the kneading apparatus is generally 20 to 2000 rpm. The composition can be produced by setting the temperature of the section between the first supply port and the second supply port at room temperature to 300° C. appropriately and setting the temperature of the section subsequent to the second supply port at 250° C. to 300° C. The resin retention time in the kneading apparatus is not particularly limited but about 0.5 to 15 minutes is sufficient.

The method for molding the thermoplastic resin composition of the present invention is not particularly limited, and it is possible to use a molding method generally used for a thermoplastic resin such as injection molding, blow molding, extrusion molding, vacuum molding, press molding or calendar molding, for example.

The composition of the present invention has excellent thermal conductivity as shown in the examples and can provide a molded article having a thermal conductivity of preferably 0.8 W/m·K or more, more preferably 1 W/m·K or more, still more preferably 1.3 W/m·K or more, and particularly preferably 2.0 W/m·K or more. When the thermoplastic resin (A) is a polyamide resin or at least one thermoplastic resin synthesized using a styrene monomer and/or (meth)acrylic monomer, the composition can provide a molded article having a thermal conductivity of preferably 4.0 W/m·K or more.

In the present invention, a highly thermally conductive inorganic compound is preferentially placed in one phase of a polymer alloy having a specific phase structure, making it possible to efficiently improve the thermal conductivity of a whole composition even if only a small amount of the highly thermally conductive inorganic compound is added. According to this technology, a highly thermally conductive resin composition, which has been inferior in moldability and impact resistance and expensive and thus has been used only in limited fields in the past, can be applied to various fields, contrary to the conventional knowledge.

The resin composition obtained by the present invention has high thermal conductivity and also has insulation properties. A highly thermally conductive material in the past has conductivity and is thus used only in a limited range for electronic material applications. However, the present invention is successful in solving such a problem at the same time.

The highly thermally conductive resin composition of the present invention can be suitably used for injection molded articles or the like such as consumer electronic components, OA equipment components, AV equipment components or automobile interior or exterior components. In particular, the composition can be suitably used as an exterior material for consumer electronic products or OA equipment generating a large amount of heat.

Further, the composition is suitably used as an external material for electronic equipment that has an internal heat source but is difficult to be forcibly cooled by a fan or the like in order to radiate heat generated in the electronic equipment to outside. The composition is extremely useful as a resin for enclosures, housings or exterior materials of small or portable electronic equipment such as portable computers including laptops, PDAs, portable telephones, portable game consoles, portable music players, portable TV/video equipment or portable video cameras as preferable kinds of the electronic equipment.

The composition can also be extremely useful as a resin around a battery in an automobile, an electric car or the like, a resin for a portable battery of consumer electronic equipment, or a resin for a power distribution component such as a breaker, utilizing characteristics of the resin having insulation properties and thermal conductivity together.

The highly thermally conductive resin composition of the present invention is superior in moldability, impact resistance and surface properties of the resulting molded article to a conventional inorganic compound-containing composition and has properties useful for a component or enclosure in the above-described applications.

### EXAMPLES

The present invention will be described in more detail below with reference to examples. However, the present invention is not limited to these examples.

The thermoplastic resins and highly thermally conductive inorganic compounds used in the examples are as follows.

### Thermoplastic Resin Excluding Thermoplastic Polyester Resin (A)

(PC-1) (polycarbonate resin): Tarflon A-2200 (manufactured by Idemitsu Kosan Co., Ltd.)
(PC-2) (polycarbonate resin): Tarflon A-2500 (manufactured by Idemitsu Kosan Co., Ltd.).
(PA-1) (nylon 6): Unitika Nylon 6 A1030BRL (manufactured by Unitika Ltd.)
(PA-2) (nylon 66): Unitika Nylon 66 A125N (manufactured by Unitika Ltd.)
(PA-3) (nylon MXD6): Reny 6002 (manufactured by Asahi Kasei Corp.)
(PA-4) (nylon 46): Stanyl TS300 (manufactured by DSM-JSR).
(ST-1) (ABS resin): Resin obtained by the method described in Reference Production Example 1
(ST-2) (general-purpose polystyrene resin): G-9305 (manufactured by PS Japan Corp.)
(ST-3) (butadiene-methyl methacrylate copolymer): Paraloid EXL-2602 (manufactured by Rohm and Haas Japan K.K.)
(ST-4) (PMMA resin): Acrypet MD (manufactured by Mitsubishi Rayon Co., Ltd.).
(PO-1) (ethylene-ethyl acrylate copolymer): Evaflex EEA-A709 (manufactured by Du Pont-Mitsui Polychemicals Co., Ltd.)
(PO-2) (ethylene-methyl acrylate-glycidyl methacrylate copolymer): Bondfast 7M (manufactured by Sumitomo Chemical Co., Ltd.)
(PO-3) (ethylene-vinyl acetate-glycidyl methacrylate copolymer): Bondfast 7B (manufactured by Sumitomo Chemical Co., Ltd.).

### Thermoplastic Polyester Resin (B)

(PES-1) (polyethylene terephthalate resin): EFG-70 (manufactured by Kanebo Gohsen, Ltd.).
(PES-2) (polybutylene terephthalate resin): Novaduran 5009L (manufactured by Mitsubishi Engineering-Plastics Corp.).

### Highly Thermally Conductive Inorganic Compound (C)

(FIL-1): Alumina powder (DAW-05 manufactured by Denki Kagaku Kogyo K.K., thermal conductivity as a single substance: 36 W/m·K, volume average particle size: 5.0 μm, electrically insulating, volume resistivity: 10¹⁶ Ω·cm)
(FIL-2): Alumina powder (AM-SFP highSSA manufactured by Denki Kagaku Kogyo K.K., thermal conductivity as a single substance: 35 W/m·K, volume average particle size: 200 nm, electrically insulating, volume resistivity: 10¹⁶ Ω·cm)
(FIL-3): Alumina powder (DAW-03 manufactured by Denki Kagaku Kogyo K.K., thermal conductivity as a single substance: 36 W/m·K, volume average particle size: 3.0 μm, electrically insulating, volume resistivity: 10¹⁶ Ω·cm)
(FIL-4): Boron nitride powder (SP-2 manufactured by Denki Kagaku Kogyo K.K., thermal conductivity as a single substance: 60 W/m·K, volume average particle size: 4.0 μm, electrically insulating, volume resistivity: 10¹⁴ Ω·cm)
(FIL-5): Boron nitride powder (HP-P1 manufactured by Mizushima Ferroalloy Co., Ltd., thermal conductivity as a single substance: 60 W/m·K, volume average particle size: 2.0 μm, electrically insulating, volume resistivity: 10¹⁴ Ω·cm)
(FIL-6): Aluminum nitride powder (H Grade manufactured by Tokuyama Corp., thermal conductivity as a single substance: 170 W/m·K, volume average particle size: 1.1 μm, electrically insulating, volume resistivity: 10¹⁶ Ω·cm)
(FIL-7): Silicon nitride powder (SN-E10 manufactured by Ube Industries, Ltd., thermal conductivity as a single substance: 50 W/m·K, volume average particle size: 500 nm, electrically insulating, volume resistivity: 10¹⁴ Ω·cm).

### Example 1

(PC-1) and (PO-1) used as the thermoplastic resin (A) and (PES-1) used as the thermoplastic polyester resin (B) were mixed at a volume ratio of (PC-1)/(PO-1)/(PES-1)=30/1/30. One hundred parts by weight in total of both components and 0.2 part by weight each of Adekastab EP-22, Adekastab AO-60 and Adekastab HP-10 (all trade names, manufactured by Asahi Denka Kogyo K.K.) as stabilizers were mixed using a superfloater (raw material 1).

Separately, 100 parts by weight of (FIL-1) as the highly thermally conductive inorganic compound (C), 1 part by weight of a silane coupling agent A-187 manufactured by Dow Corning Toray Co., Ltd. and 10 parts by weight of ethanol were mixed using a superfloater, stirred for five minutes and then dried at 80° C. for four hours (raw material 2).

The raw material 1 was introduced from a hopper as a first supply port provided near the root of the screw in a co-rotating intermeshed twin-screw extruder TEX44 manufactured by The Japan Steel Works, Ltd. A kneading disk at an angle of 90° C. was inserted into the screw in a position in front of a second supply port. A vent port opened to atmospheric pressure was provided in a position with the kneading disk terminated. A side feeder was placed immediately adjacent to the vent port, and the raw material 2 was forcibly injected from the second supply port using the side feeder. The ratio of the highly thermally conductive inorganic compound (C) was set so that the volume ratio of the component (C) to the components {(A)+(B)} was 39/61.

A vacuum vent port connected to a vacuum pump was provided in the center between the second supply port and the tip of the screw. The number of screw revolutions was set at 150 rpm and the discharge amount per hour was set at 20 kg/hr. The temperature was set at 100° C. near the first supply port. By sequentially increasing the set temperature, the temperature was set at 275° C. in front of the kneading disk. The temperature was set at 270° C. between the kneading disk and the tip of the screw. An evaluation sample pellet was obtained under these conditions.

### Examples 2 to 7, Comparative Examples 1 to 5

An evaluation sample pellet was obtained in the same manner as in Example 1, except that the type and amount of the resins used were changed as shown in Tables 1 and 2. The raw materials were not introduced from the second supply port in Comparative Example 5.

### [Moldability]

Melt viscosity of the resulting pellet was measured using a capillary rheometer manufactured by Toyo Seiki Seisaku-Sho, Ltd. at the same set temperature as the temperature during extrusion under the conditions where the preheating time was five minutes, the capillary size was 1 mmφ×10 mm and the shear rate was 608 sec⁻¹.

### [Measurement of Presence Ratio and Determination of Continuous Phase Structure in Highly Thermally Conductive Inorganic Compound (C)]

The resulting pellet having a diameter of about 3.6 mm was cut in the center to prepare an extremely thin section in the pellet center. The section was stained with ruthenium and then observed under a transmission electron microscope. It was determined whether or not the thermoplastic polyester resin formed a continuous phase by a method of observing the phase structures of the stained place and the non-stained place, respectively, based on the electron micrograph of the pellet center section.

The area of inorganic particles present in the thermoplastic resin phase excluding a thermoplastic polyester resin (A) and the area of inorganic particles present in the thermoplastic polyester resin phase were calculated and the area ratio is converted into the volume ratio. Accordingly, the ratio of the highly thermally conductive inorganic compound (C) present in the phase of the thermoplastic resin excluding a thermoplastic polyester resin (A) was calculated from the volume ratio.

### [Molding of Test Piece]

The resulting sample pellets were dried and then molded into a test piece of 127 mm×12.7 mm×thickness 1.0 mm, a test piece of 127 mm×12.7 mm×thickness 3.2 mm and a flat plate of 120 mm×120 mm×thickness 3 mm, respectively, using an injection molding machine.

### [Impact Resistance]

The test piece having a thickness of 3.2 mm was cut in the center to prepare a sample. Then, the sample was allowed to stand at 23° C. and at a humidity of 50% for one week and then the unnotched Izod impact strength was measured according to ASTM D256.

### [Thermal Conductivity]

Both surfaces of the test piece having a thickness of 1.0 mm were coated with a graphite spray. Then, the specific heat and thermal diffusivity of the sample in the room temperature atmosphere were measured using a laser flash method thermal constant measuring apparatus manufactured by ULVAC-RIKO, Inc. The thermal conductivity of the composition was calculated based on the density of the test piece separately measured.

### [Electrical Insulating Properties]

The volume resistivity of the flat plate of 120×120×thickness 3 mm was measured according to ASTM D-257.

The respective formulations and results are shown in Tables 1 to 2.

TABLE 1

| | No./unit | Ex. 1 | Ex. 2 | Ex. 3 | Ex. 4 | Ex. 5 | Ex. 6 | Ex. 7 |
|---|---|---|---|---|---|---|---|---|
| Thermoplastic resin | PC-1 | 30 | 38 | 12 | 30 | 30 | 30 | 30 |
| excluding | PC-2 | | | | | | | |
| thermoplastic | PO-1 | 1 | | | | | | |
| polyester (A) | | | | | | | | |
| Thermoplastic | PES-1 | 30 | 38 | 24 | | 30 | 30 | 30 |
| polyester resin (B) | PES-2 | | | | 30 | | | |
| (A)/(A) + (B) | Volume fraction: % | 51 | 50 | 33 | 50 | 50 | 50 | 50 |
| Highly thermally | FIL-1 | 39 | 24 | 64 | 40 | | | |
| conductive inorganic | FIL-2 | | | | | 40 | | |
| compound (C) | FIL-4 | | | | | | 40 | |
| | FIL-6 | | | | | | | 40 |
| Extruder set | ° C. | 270 | 270 | 270 | 270 | 270 | 270 | 270 |
| temperature | | | | | | | | |
| Moldability | Pa · sec | 200 | 280 | 190 | 250 | 260 | 200 | 210 |
| Ratio of component | Presence ratio in resin | 7.5 | 3.5 | 4.0 | 8.2 | 2.7 | 6.3 | 4.9 |
| (C) present | (A): % | | | | | | | |
| Continuous phase | Resin (A) phase | Continuous | Continuous | Continuous | Continuous | Continuous | Continuous | Continuous |
| structure | | phase | phase | phase | phase | phase | phase | phase |
| | Resin (B) phase | Continuous | Continuous | Continuous | Continuous | Continuous | Continuous | Continuous |
| | | phase | phase | phase | phase | phase | phase | phase |
| Impact resistance | J/m | 800 | 980 | 450 | 820 | 1200 | 800 | 850 |
| Thermal conductivity | W/m · K | 1.2 | 0.95 | 2.5 | 1.1 | 1.0 | 1.6 | 1.9 |
| Electrical insulating | Ω · cm | 10¹⁶ | 10¹⁶ | 10¹⁶ | 10¹⁶ | 10¹⁶ | 10¹⁶ | 10¹⁶ |
| properties | | | | | | | | |

Note)
The formulation ratios are all indicated by vol %.

TABLE 2

| | | Comp. Ex. | Comp. Ex. | Comp. Ex. | Comp. Ex. | Comp. Ex. |
|---|---|---|---|---|---|---|
| | No./unit | 1 | 2 | 3 | 4 | 5 |
| Thermoplastic resin | PC-1 | 48 | 20 | 7 | | 50 |
| excluding | PC-2 | | | | | |
| thermoplastic | PO-1 | | | | | |
| polyester (A) | | | | | | |
| Thermoplastic | PES-1 | 12 | 5 | 8 | 60 | 50 |
| polyester resin (B) | PES-2 | | | | | |
| (A)/(A) + (B) | Volume fraction: % | 80 | 80 | 47 | 0 | 50 |
| Highly thermally | FIL-1 | 40 | 75 | 85 | 40 | |
| conductive inorganic | FIL-2 | | | | | |
| compound (C) | FIL-4 | | | | | |
| | FIL-6 | | | | | |
| Extruder set | ° C. | 270 | 270 | 270 | 270 | 270 |
| temperature | | | | | | |
| Moldability | Pa · sec | 170 | 25 | Difficult to | 350 | 290 |
| | | | | mold | | |
| Ratio of component | Presence ratio in resin | 35 | 60 | Not | 0 | — |
| (C) present | (A): % | | | measurable | | |
| Continuous phase | Resin (A) phase | Continuous | Continuous | Not | — | Continuous |
| structure | | phase | phase | measurable | | phase |
| | Resin (B) phase | Island | Island | Not | Continuous | Continuous |
| | | phase | phase | measurable | phase | phase |
| Impact resistance | J/m | 950 | 50 | Not | 100 | Not broken |
| | | | | measurable | | |
| Thermal conductivity | W/m · K | 0.45 | 1.9 | Not | 0.47 | 0.16 |
| | | | | measurable | | |
| Electrical insulating | Ω · cm | 10¹⁶ | 10¹⁶ | Not | 10¹⁶ | 10¹⁶ |
| properties | | | | measurable | | |

### Example 8

(PA-1) and (PO-2) used as the thermoplastic resin (A) and (PES-2) used as the thermoplastic polyester resin (B) were mixed at a volume ratio of (PA-1)/(PO-2)/(PES-2)=27/6/27. To 100 parts by weight in total of both components, 0.2 part by weight of a phenol stabilizer and 0.2 part by weight of a sulfur stabilizer were added as stabilizers, and (PO-2) as another resin was added after calculating to make the ratio of (PO-2) 6 vol % in the composition including the component (C). Thereafter, the components were mixed using a superfloater (raw material 3).

Separately, 100 parts by weight of (FIL-2) as the highly thermally conductive inorganic compound (C), 5 parts by weight of epoxysilane KBM-303 manufactured by Shin-Etsu Chemical Co., Ltd. and 10 parts by weight of ethanol were mixed using a superfloater, stirred for five minutes and then dried at 80° C. for four hours (raw material 4).

The raw material 3 was introduced from a hopper as a first supply port provided near the root of the screw in a co-rotating intermeshed twin-screw extruder TEX44 manufactured by The Japan Steel Works, Ltd. A kneading disk at an angle of 90° C. was inserted into the screw in a position in front of a second supply port. A vent port opened to atmospheric pressure was provided in a position with the kneading disk terminated. A side feeder was placed immediately adjacent to the vent port, and the raw material 4 was forcibly injected from the second supply port using the side feeder. The ratio of the highly thermally conductive inorganic compound (C) to the thermoplastic resin (A) and the thermoplastic polyester resin (B) in total was set so that the volume ratio of the component (C) to the components {(A)+(B)} was 40/60.

A vacuum vent port connected to a vacuum pump was provided in the center between the second supply port and the tip of the screw. The number of screw revolutions was set at 150 rpm and the discharge amount per hour was set at 20 kg/hr. The temperature was set at 100° C. near the first supply port. By sequentially increasing the set temperature, the temperature was set at 265° C. in front of the kneading disk. The temperature was set at 260° C. between the kneading disk and the tip of the screw. An evaluation sample pellet was obtained under these conditions.

### Examples 9 to 18, Comparative Examples 6 to 10

An evaluation sample pellet was obtained in the same manner as in Example 8, except that the type and amount of the resins used, the type and amount of the highly thermally conductive inorganic compound used and the set temperature of the screw tip during extrusion were changed as shown in Tables 3 and 4. The raw materials were not introduced from the second supply port in Comparative Example 10. The respective formulations and results are shown in Tables 3 to 4.

TABLE 3

| | No./unit | Ex. 8 | Ex. 9 | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|---|---|---|
| Thermoplastic | PA-1 | 27 | 34 | 11 | | | | 27 | 27 | 27 | 27 | 27 |
| resin excluding | PA-2 | | | | 27 | | | | | | | |
| thermoplastic | PA-3 | | | | | 27 | | | | | | |
| polyester (A) | PA-4 | | | | | | 27 | | | | | |
| | PO-2 | 6 | 8 | 4 | 6 | 6 | 6 | | 6 | 6 | 6 | 6 |
| | PO-3 | | | | | | | 6 | | | | |
| Thermoplastic | PES-1 | | | | | | | 27 | | | | |
| polyester resin | PES-2 | 27 | 34 | 22 | 27 | 27 | 27 | | 27 | 27 | 27 | 27 |
| (B) | | | | | | | | | | | | |
| (A)/(A) + (B) | Volume fraction: % | 55 | 55 | 41 | 55 | 55 | 55 | 55 | 55 | 55 | 55 | 55 |
| Highly thermally | FIL-2 | 40 | 24 | 63 | 40 | 40 | 40 | 40 | | | | |
| conductive | FIL-3 | | | | | | | | 40 | | | |
| inorganic | FIL-5 | | | | | | | | | 40 | | |
| compound (C) | FIL-6 | | | | | | | | | | 40 | |
| | FIL-7 | | | | | | | | | | | 40 |
| Extruder set | ° C. | 260 | 260 | 260 | 280 | 300 | 320 | 270 | 260 | 260 | 260 | 260 |
| temperature | | | | | | | | | | | | |
| Moldability | Pa · sec | 240 | 290 | 210 | 240 | 250 | 210 | 220 | 220 | 250 | 240 | 220 |
| Ratio of | Presence ratio in resin | 1.2 | 0.8 | 2.0 | 1.5 | 3.0 | 3.5 | 3.0 | 3.0 | 1.9 | 1.8 | 2.0 |
| component (C) | (A): % | | | | | | | | | | | |
| present | | | | | | | | | | | | |
| Continuous phase | Resin (A) phase | Contin- | Contin- | Contin- | Contin- | Contin- | Contin- | Contin- | Contin- | Contin- | Contin- | Contin- |
| structure | | uous | uous | uous | uous | uous | uous | uous | uous | uous | uous | uous |
| | | phase | phase | phase | phase | phase | phase | phase | phase | phase | phase | phase |
| | Resin (B) phase | Contin- | Contin- | Contin- | Contin- | Contin- | Contin- | Contin- | Contin- | Contin- | Contin- | Contin- |
| | | uous | uous | uous | uous | uous | uous | uous | uous | uous | uous | uous |
| | | phase | phase | phase | phase | phase | phase | phase | phase | phase | phase | phase |
| Impact resistance | J/m | 740 | 750 | 400 | 720 | 600 | 580 | 600 | 700 | 700 | 650 | 720 |
| Thermal | W/m · K | 1.6 | 1.2 | 4.3 | 1.9 | 1.8 | 2.1 | 1.7 | 2.1 | 3.2 | 4.6 | 3.1 |
| conductivity | | | | | | | | | | | | |
| Electrical | Ω · cm | 10¹⁶ | 10¹⁶ | 10¹⁶ | 10¹⁶ | 10¹⁶ | 10¹⁶ | 10¹⁶ | 10¹⁶ | 10¹⁶ | 10¹⁶ | 10¹⁶ |
| insulating | | | | | | | | | | | | |
| properties | | | | | | | | | | | | |

Note)
The formulation ratios are all indicated by vol %.

TABLE 4

| | | Comp. Ex. | Comp. Ex. | Comp. Ex. | Comp. Ex. | Comp. Ex. |
|---|---|---|---|---|---|---|
| | No./unit | 6 | 7 | 8 | 9 | 10 |
| Thermoplastic resin | PA-1 | 44 | 16 | 7 | | 45 |
| excluding | PA-2 | | | | | |
| thermoplastic | PA-3 | | | | | |
| polyester (A) | PA-4 | | | | | |
| | PO-2 | 5 | 3 | 1 | 6 | 10 |
| | PO-3 | | | | | |
| Thermoplastic | PES-1 | | | | | |
| polyester resin (B) | PES-2 | 11 | 4 | 7 | 54 | 45 |
| (A)/(A) + (B) | Volume fraction: % | 82 | 76 | 53 | 10 | 55 |
| Highly thermally | FIL-2 | 40 | 75 | 85 | 40 | |
| conductive inorganic | FIL-3 | | | | | |
| compound (C) | FIL-5 | | | | | |
| | FIL-6 | | | | | |
| | FIL-7 | | | | | |
| Extruder set | ° C. | 260 | 260 | 260 | 260 | 260 |
| temperature | | | | | | |
| Moldability | Pa · sec | 150 | 20 | Difficult to | 220 | 290 |
| | | | | mold | | |
| Ratio of component | Presence ratio in resin | 40 | 58 | Not | 0 | — |
| (C) present | (A): % | | | measurable | | |
| Continuous phase | Resin (A) phase | Continuous | Continuous | Not | — | Continuous |
| structure | | phase | phase | measurable | | phase |
| | Resin (B) phase | Island | Island | Not | Continuous | Continuous |
| | | phase | phase | measurable | phase | phase |
| Impact resistance | J/m | 850 | 50 | Not | 90 | Not broken |
| | | | | measurable | | |
| Thermal conductivity | W/m · K | 0.60 | 2.0 | Not | 0.50 | 0.20 |
| | | | | measurable | | |
| Electrical insulating | Ω · cm | 10¹⁶ | 10¹⁶ | Not | 10¹⁶ | 10¹⁶ |
| properties | | | | measurable | | |

### Reference Production Example 1

### Production of Styrene Resin (ST-1)

The following substances were put into a reaction can reactor equipped with a stirrer and a reflux cooler in a nitrogen stream. Two hundred and fifty parts of water, 0.4 part of sodium formaldehyde sulfoxylate, 0.0025 part of ferrous sulfate, 0.01 part of disodium ethylenediaminetetraacetate and 2.0 parts of sodium dioctylsulfosuccinate were heated to 60° C. and stirred. Then, 70 parts by weight of α-methylstyrene, 25 parts by weight of acrylonitrile and 5 parts by weight of styrene were continuously added dropwise over six hours together with 0.3 part by weight of cumene hydroperoxide as an initiator and 0.5 part by weight of t-dodecylmercaptan as a polymerization degree regulator. After completion of the dropwise addition, the mixture was further stirred at 60° C. for one hour and polymerization was completed to give a copolymer (i).

Next, the following substances were put into a reactor equipped with a stirrer and a reflux cooler in a nitrogen stream. Two hundred and fifty parts of water, 0.5 part of potassium persulfate, 100 parts of butadiene, 0.3 part of t-dodecylmercaptan and 3.0 parts of disproportionated sodium rosinate were polymerized at a polymerization temperature of 60° C. When the rate of polymerization of butadiene was 80%, polymerization was stopped and the unreacted butadiene was removed to give a polybutadiene latex (X) as a rubbery polymer. Here, the polybutadiene rubber had an average particle size of 0.30 μm.

Further, the following substances were put into a reactor equipped with a stirrer and a reflux cooler in a nitrogen stream. Two hundred and fifty parts of water, 0.4 part of sodium formaldehyde sulfoxylate, 0.0025 part of ferrous sulfate, 0.01 part of disodium ethylenediaminetetraacetate and 70 parts by weight % of polybutadiene [(X) obtained above] were heated to 60° C. and stirred. Then, 10 parts by weight of styrene and 20 parts by weight of methyl methacrylate were continuously added dropwise over five hours together with 0.3 part by weight of cumene hydroperoxide as an initiator and 0.2 part by weight of t-dodecylmercaptan as a polymerization degree regulator. After completion of the dropwise addition, the mixture was further stirred at 60° C. for one hour and polymerization was completed to give a graft copolymer (ii).

The ABS resin (ST-1) was obtained by homogeneously mixing 64 wt % of the latex of the copolymer (i) and 36 wt % of the latex of the graft copolymer (ii) obtained above, adding a phenol antioxidant, coagulating with an aqueous magnesium chloride solution, and then washing with water, dehydrating and drying.

### Example 19

(ST-1) used as the thermoplastic resin (A) and (PES-2) used as the thermoplastic polyester resin (B) were mixed at a volume ratio of (ST-1)/(PES-2)=30/30. One hundred parts by weight in total of both components and 0.2 part by weight of Adekastab AO-80 (trade name, manufactured by Asahi Denka Kogyo K.K.) as a stabilizer were mixed using a superfloater (raw material 5).

Separately, 100 parts by weight of (FIL-2) as the highly thermally conductive inorganic compound (C), 5 parts by weight of epoxysilane KBM-303 manufactured by Shin-Etsu Chemical Co., Ltd. and 10 parts by weight of ethanol were mixed using a superfloater, stirred for five minutes and then dried at 80° C. for four hours (raw material 6).

The raw material 5 was introduced from a hopper as a first supply port provided near the root of the screw in a co-rotating intermeshed twin-screw extruder TEX44 manufactured by The Japan Steel Works, Ltd. A kneading disk at an angle of 90° C. was inserted into the screw in a position in front of a second supply port. A vent port opened to atmospheric pressure was provided in a position with the kneading disk terminated. A side feeder was placed immediately adjacent to the vent port, and the raw material 6 was forcibly injected from the second supply port using the side feeder. The ratio of the highly thermally conductive inorganic compound (C) to the thermoplastic resin (A) and the thermoplastic polyester resin (B) in total was set so that the volume ratio of the component (C) to the components {(A)+(B)} was 40/60.

A vacuum vent port connected to a vacuum pump was provided in the center between the second supply port and the tip of the screw. The number of screw revolutions was set at 150 rpm and the discharge amount per hour was set at 20 kg/hr. The temperature was set at 100° C. near the first supply port. By sequentially increasing the set temperature, the temperature was set at 245° C. in front of the kneading disk. The temperature was set at 240° C. between the kneading disk and the tip of the screw. An evaluation sample pellet was obtained under these conditions.

### Examples 20 to 26, Comparative Examples 11 to 15

An evaluation sample pellet was obtained in the same manner as in Example 19, except that the type and amount of the resins used, the type and amount of the highly thermally conductive inorganic compound used and the set temperature of the screw tip during extrusion were changed as shown in Tables 5 and 6. The raw materials were not introduced from the second supply port in Comparative Example 15. The respective formulations and results are shown in Tables 5 to 6.

TABLE 5

| | No./unit | Ex. 19 | Ex. 20 | Ex. 21 | Ex. 22 | Ex. 23 | Ex. 24 | Ex. 25 | Ex. 26 |
|---|---|---|---|---|---|---|---|---|---|
| Thermoplastic resin | ST-1 | 30 | 38 | 12 | 30 | 30 | 30 | | |
| excluding | ST-2 | | | | | | | 20 | |
| thermoplastic | ST-3 | | | | | | | 10 | 10 |
| polyester (A) | ST-4 | | | | | | | | 20 |
| Thermoplastic | PES-1 | | | | | | 30 | | |
| polyester resin (B) | PES-2 | 30 | 38 | 24 | 30 | 30 | | 30 | 30 |
| (A)/(A) + (B) | Volume fraction: % | 50 | 50 | 33 | 50 | 50 | 50 | 50 | 50 |
| Highly thermally | FIL-2 | 40 | | | | | | | 40 |
| conductive inorganic | FIL-3 | | 24 | 64 | 40 | | | | |
| compound (C) | FIL-5 | | | | | 40 | | | |
| | FIL-6 | | | | | | 40 | | |
| | FIL-7 | | | | | | | 40 | |
| Extruder set | ° C. | 240 | 240 | 240 | 240 | 240 | 240 | 240 | 240 |
| temperature | | | | | | | | | |
| Moldability | Pa · sec | 250 | 350 | 200 | 310 | 220 | 250 | 290 | 270 |
| Ratio of component | Presence ratio in resin | 0.6 | 0.6 | 1.9 | 0.9 | 2.2 | 2.8 | 2.1 | 0.8 |
| (C) present | (A): % | | | | | | | | |
| Continuous phase | Resin (A) phase | Contin- | Contin- | Contin- | Contin- | Contin- | Contin- | Contin- | Contin- |
| structure | | uous | uous | uous | uous | uous | uous | uous | uous |
| | | phase | phase | phase | phase | phase | phase | phase | phase |
| | Resin (B) phase | Contin- | Contin- | Contin- | Contin- | Contin- | Contin- | Contin- | Contin- |
| | | uous | uous | uous | uous | uous | uous | uous | uous |
| | | phase | phase | phase | phase | phase | phase | phase | phase |
| Impact resistance | J/m | 720 | 810 | 400 | 650 | 700 | 480 | 500 | 690 |
| Thermal conductivity | W/m · K | 1.8 | 1.3 | 4.5 | 2.6 | 3.4 | 2.7 | 2.6 | 1.9 |
| Electrical insulating | Ω · cm | 10¹⁶ | 10¹⁶ | 10¹⁶ | 10¹⁶ | 10¹⁶ | 10¹⁶ | 10¹⁶ | 10¹⁶ |
| properties | | | | | | | | | |

Note)
The formulation ratios are all indicated by vol %.

TABLE 6

| | | Comp. Ex. | Comp. Ex. | Comp. Ex. | Comp. Ex. | Comp. Ex. |
|---|---|---|---|---|---|---|
| | No./unit | 11 | 12 | 13 | 14 | 15 |
| Thermoplastic resin | ST-1 | 48 | 20 | 7 | | 50 |
| excluding | ST-2 | | | | | |
| thermoplastic | ST-3 | | | | | |
| polyester (A) | ST-4 | | | | | |
| Thermoplastic | PES-1 | | | | | |
| polyester resin (B) | PES-2 | 12 | 5 | 8 | 60 | 50 |
| (A)/(A) + (B) | Volume fraction: % | 80 | 80 | 47 | 0 | 50 |
| Highly thermally | FIL-2 | 40 | 75 | 85 | 40 | |
| conductive inorganic | FIL-3 | | | | | |
| compound (C) | FIL-5 | | | | | |
| | FIL-6 | | | | | |
| | FIL-7 | | | | | |
| Extruder set | ° C. | 240 | 240 | 240 | 240 | 240 |
| temperature | | | | | | |
| Moldability | Pa · sec | 120 | 20 | Difficult to | 270 | 330 |
| | | | | mold | | |
| Ratio of component | Presence ratio in resin | 33 | 50 | Not | 0 | — |
| (C) present | (A): % | | | measurable | | |
| Continuous phase | Resin (A) phase | Continuous | Continuous | Not | — | Continuous |
| structure | | phase | phase | measurable | | phase |
| | Resin (B) phase | Island | Island | Not | Continuous | Continuous |
| | | phase | phase | measurable | phase | phase |
| Impact resistance | J/m | 820 | 50 | Not | 90 | Not broken |
| | | | | measurable | | |
| Thermal conductivity | W/m · K | 0.5 | 1.7 | Not | 0.5 | 0.2 |
| | | | | measurable | | |
| Electrical insulating | Ω · cm | 10¹⁶ | 10¹⁶ | Not | 10¹⁶ | 10¹⁶ |
| properties | | | | measurable | | |

In Comparative Example 1, since the volume ratio of the component (A) to the component (B) was outside the scope of the present invention, the effect of improving the thermal conductivity was inferior. In Comparative Example 2, although the volume ratio of the component (C) was increased with the volume ratio of the component (A) to the component (B) unchanged in order to further improve the thermal conductivity, moldability and impact resistance significantly deteriorated. In Comparative Example 3, since the volume ratio of the component (C) was outside the scope of the present invention, molding was difficult. In Comparative Example 4, since the volume ratio of the component (A) to the component (B) was outside the scope of the present invention, impact resistance and the like were decreased and furthermore the thermal conductivity was not improved as expected.

In Comparative Example 5, since the volume ratio of the component (C) was outside the scope of the present invention, the thermal conductivity was low. In Comparative Example 6, since the volume ratio of the component (A) to the component (B) was outside the scope of the present invention, the effect of improving the thermal conductivity was inferior. In Comparative Example 7, although the volume ratio of the component (C) was increased with the volume ratio of the component (A) to the component (B) unchanged in order to further improve the thermal conductivity, moldability and impact resistance significantly deteriorated. In Comparative Example 8, since the volume ratio of the component (C) was outside the scope of the present invention, molding was difficult. In Comparative Example 9, since the volume ratio of the component (A) to the component (B) was outside the scope of the present invention, impact resistance and the like were decreased and furthermore the thermal conductivity was not improved as expected. In Comparative Example 10, since the volume ratio of the component (C) was outside the scope of the present invention (the component (C) is not used), the thermal conductivity was low.

In Comparative Example 11, since the volume ratio of the component (A) to the component (B) was outside the scope of the present invention, the effect of improving the thermal conductivity was inferior. In Comparative Example 12, although the volume ratio of the component (C) was increased with the volume ratio of the component (A) to the component (B) unchanged in order to further improve the thermal conductivity, moldability and impact resistance significantly deteriorated. In Comparative Example 13, since the volume ratio of the component (C) was outside the scope of the present invention, molding was difficult. In Comparative Example 14, since the volume ratio of the component (A) to the component (B) was outside the scope of the present invention, impact resistance and the like were decreased and furthermore the thermal conductivity was not improved as expected. In Comparative Example 15, since the volume ratio of the component (C) was outside the scope of the present invention (the component (C) was not used), the thermal conductivity was low.

As is clear from above, only by adding to the thermoplastic resin composition of the present invention a smaller amount of a highly thermally conductive inorganic compound than that of a conventionally known composition, the thermal conductivity of the composition can be efficiently improved, and the composition and a highly thermally conductive molded article molded using the resin composition are obtained with an excellent balance between various properties and thermal conductivity, at a low cost and with electrical insulation properties.

1-9. (canceled)

10. A highly thermally conductive thermoplastic resin composition comprising:
a thermoplastic resin excluding a thermoplastic polyester resin (A), a thermoplastic polyester resin (B) and a highly thermally conductive inorganic compound having a thermal conductivity of 1.5 W/m·K or more as a single substance (C),
wherein 1): the volume ratio of the component (A) to the component (B) is 15/85 to 75/25,
2): the volume ratio of the component (C) to the components {(A)+(B)} is 10/90 to 75/25,
3): the ratio of the component (C) present in a phase of the component (A) is a volume fraction of the component (A)×0.4 or less, and
4): at least the component (B) forms a continuous phase structure.

11. The highly thermally conductive thermoplastic resin composition according to claim 10, wherein the component (C) is a highly thermally conductive inorganic compound having electrical insulation properties.

12. The highly thermally conductive thermoplastic resin composition according to claim 10, wherein the component (C) has a volume average particle size of 1 nm or more and 12 μm or less and is one or more selected from metal oxide fine particles, metal nitride fine particles and insulating carbon fine particles.

13. The highly thermally conductive thermoplastic resin composition according to claim 10, wherein the component (C) contains at least one selected from boron nitride, aluminum nitride, silicon nitride, aluminum oxide, magnesium oxide, beryllium oxide and diamond.

14. The highly thermally conductive thermoplastic resin composition according to claim 10, wherein the thermoplastic resin excluding a thermoplastic polyester resin (A) is a polycarbonate resin.

15. The highly thermally conductive thermoplastic resin composition according to claim 10, wherein the thermoplastic resin excluding a thermoplastic polyester resin (A) is a polyamide resin.

16. The highly thermally conductive thermoplastic resin composition according to claim 10, wherein the thermoplastic resin excluding a thermoplastic polyester resin (A) is at least one thermoplastic resin synthesized using a styrene monomer and/or (meth)acrylic monomer.

17. A highly thermally conductive molded article molded using the highly thermally conductive thermoplastic resin composition according to claim 10.

18. The highly thermally conductive molded article according to claim 17, wherein both the thermoplastic resin excluding a thermoplastic polyester resin (A) and the thermoplastic polyester resin (B) form a continuous phase structure.
